(19) United States
(12) Patent Application Publication
(10) Pub. No.: US 2006/0171254 A1
(43) Pub. Date: Aug. 3, 2006

(54) Image data processing device, method of processing image data and storage medium storing image data processing

(75) Inventors: Ayumi Onishi, Ebina-shi (JP); Nobuo Inoue, Ebina-shi (JP); Minoru Sodeura, Ebina-shi (JP); Masataka Kamiya, Ebina-shi (JP); Junji Kannari, Ebina-shi (JP); Sadao Furuoya, Ebina-shi (JP); Norio Hasegawa, Saitama-shi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/298,781

(22) Filed: Dec. 12, 2005

(30) Foreign Application Priority Data
Jan. 19, 2005 (JP) 2005-011540

(51) Int. Cl. G01V 1/00

(52) U.S. Cl. 367/50

(57) ABSTRACT

An image data processing device has an image identifying unit and a file generating unit. The image identifying unit identifies a common image that is common to each page and a non-common image that differs from page to page on the basis of inputted image data including a plurality of pages. The file generating unit generates separate files of the common image and the non-common image.

### BACKGROUND

1. Technical Field

This invention relates to an image data processing device that processes image data and particularly to an image data processing device that performs image processing to separate a common image and a non-common image.

2. Related Art

Recently, for many documents handled at corporate offices, public offices, schools, electronic image data such as document data prepared and saved by a personal computer or the like and document data inputted by reading a draft image with a scanner or the like have been increasingly used as well as documents printed or copied on paper.

When printing out such image data including tens of pages, or when transferring the file of the image data, the quantity of image data is too large, causing a problem of long reading and transfer time for printing the image data or a problem of network jam.

A technique disclosed in JP-A-2002-27228 is constructed to remove and output a common part when printing out image data.

Another technique disclosed in JP-A-9-106450 is constructed to set common background data if the background colors of image data have common density among individual pages.

However, the above-described related arts have the following problems. Since a common image is removed from an image including plural pages, there is a problem that the common part of the image including plural pages is not saved and that an operation to separately prepare the common part is necessary.

Moreover, there is a problem that a common pattern or character cannot be recognized and managed over plural pages as part in common.

### SUMMARY

The present invention has been made in view of the above circumstances and provides an image data processing device that enables significant reduction in quantity of data by identifying a common image and a non-common image of image data of each page, of input image data including plural pages, and processing the non-common image and also processing the common image as a common image.

According to an aspect of the invention, an image data processing device for performing predetermined processing to inputted image data including plural pages includes: an image identifying unit that identifies a common image that is common to each page and a non-common image that differs from page to page on the basis of the inputted image data including plural pages; and a file generating unit that generates separate files of the common image that is common to each page and the non-common image that differs from page to page, identified by the image identifying unit.

### BRIEF DESCRIPTION OF THE DRAWINGS

Embodiments of the invention will be described in detail based on the following figures, wherein:

FIG. 1 is a block diagram showing an image data processing device according to an aspect of the invention;

FIG. 2 is a configurational view showing an image processing system to which the image data processing device according to an aspect of the invention is applied;

FIG. 3 is a configurational view showing a color multifunction machine as an image output device to which the image data processing device according to an aspect of the invention is applied;

FIG. 4 is a configurational view showing an image forming section of the color multifunction machine as an image output device to which the image data processing device according to an aspect of the invention is applied;

FIG. 5 is a configurational view showing an image reading device to which the image data processing device according to an aspect of the invention can be applied;

FIG. 6 is an explanatory view showing a document with its image processed by the image data processing device according to an aspect of the invention;

FIGS. 7A and 7B are explanatory views showing an operation of image processing by the image data processing device according to an aspect of the invention;

FIG. 8 is an explanatory view showing an operation of image processing by the image data processing device according to an aspect of the invention;

FIG. 9 is an explanatory view showing an operation of image processing by the image data processing device according to an aspect of the invention;

FIG. 10 is an explanatory view showing an operation of image processing by the image data processing device according to an aspect of the invention;

FIG. 11 is an explanatory view showing an operation of image processing by the image data processing device according to an aspect of the invention;

FIG. 12 is an explanatory view showing an operation of image processing by the image data processing device according to an aspect of the invention;

FIG. 13 is an explanatory view showing an operation of image processing by the image data processing device according to an aspect of the invention;

FIG. 14 is an explanatory view showing an operation of image processing by the image data processing device according to an aspect of the invention; and

FIG. 15 is a chart showing a file prepared by the image data processing device according to an aspect of the invention.

### DETAILED DESCRIPTION

Hereinafter, an embodiment of this invention will be described with reference to the drawings.

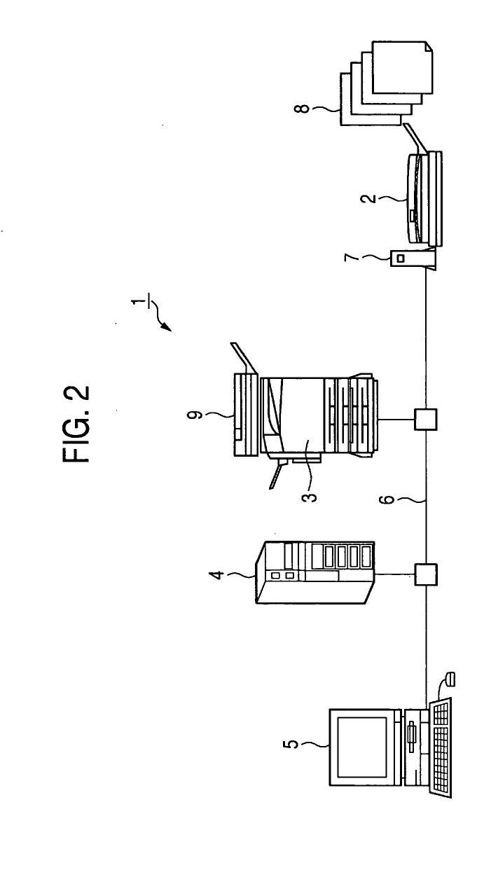

FIG. 2 shows an image processing system to which an image data processing device according to an aspect of the present invention is applied.

Positional deviation or skew of image sometimes occur when an image processing is performed. Therefore, firstly, an example of an image processing system is explained and then an image data processing device according to an aspect of the present invention is explained.

This image processing system 1 includes a scanner 2 as an image reading device that is singly installed, a color multifunction machine 3 as an image output device, a server 4 as a database, a personal computer 5 as an image producing device, and a network 6 including LAN, telephone line or the like that communicates with each other as shown in FIG. 2. In FIG. 2, reference numeral 7 represents a communication modem that connects the scanner 2 to the network 6 to enable communication.

When converting a document 8 or the like including plural pages to electronic data, the scanner 2 sequentially reads images of the document 8 and outputs the converted document 8. The image data of the document 8 is sent to the color multifunction machine 3. After predetermined image processing is performed to the image data by an image processing device provided within the color multifunction machine 3, the image data is printed out or desired processing is performed thereto by an image data processing device attached to the image processing device. Other than being provided in the color multifunction machine 3, the image data processing device may be installed in the personal computer 5 as software for image data processing, and the personal computer 5 itself may function as an image data processing device.

The color multifunction machine 3 itself has a scanner 9 as an image reading device. The color multifunction machine 3 functions as a facsimile machine that copies an image of a document read by the scanner 9, performs print based on image data sent from the personal computer 5 or read out from the server 4, and sends and receives image data via a telephone line or the like.

The server 4 directly stores the electronic image data of the document 8 or stores and holds data that are read by the scanners 2 and 9, processed with predetermined image processing by the image data processing device and filed.

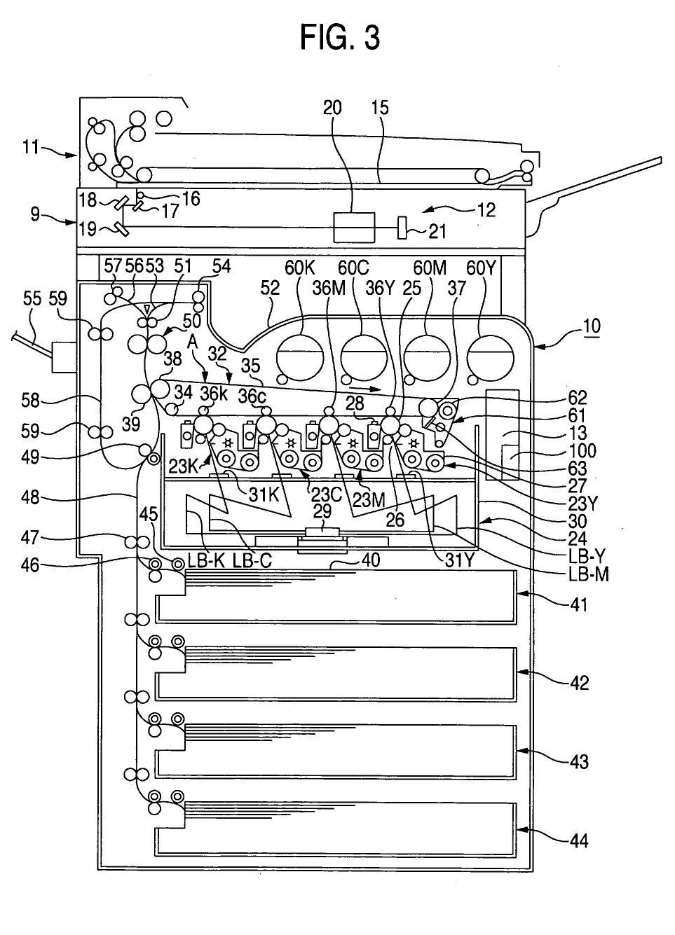

FIG. 3 shows a color multifunction machine as an image output device to which the image data processing device according to an aspect of the invention is applied.

In FIG. 3, reference numeral 10 represents the body of the color multifunction machine. At the top of the color multifunction machine, the scanner 9 is provided as an image reading device including an automatic draft feeder (ADF) 11 that automatically feeds each page of the document 8 one by one and an image input device (IIT) 12 that reads images of the document 8 fed by the automatic draft feeder 11. The scanner 2 has the same construction as the scanner 9. In the image input device 12, the document 8 set on a platen glass 15 is illuminated by a light source 16, and a return light image from the document 8 is scanned and exposed onto an image reading element 21 made up of CCD or the like via a contraction optical system including a full-rate mirror 17, half-rate mirrors 18, 19 and an image forming lens 20. Then, the color return light image of the document 8 is read by the image reading element 21 at a predetermined dot density (for example, 16 dots/mm).

The return light image of the document 8 read by the image input device 12 is sent to an image processing device 13 (IPS), for example, as reflectance data of three colors of red (R), green (G) and blue (B) (eight bits each). The image processing device 13 performs predetermined image processing to the image data of the document 8 in accordance with the need, as will be described later, that is, processing such as shading correction, misalignment correction, lightness/color space conversion, gamma correction, edge erase, and color/shift editing. The image processing device 13 also performs predetermined image processing to image data sent from the personal computer 5 or the like. The image processing device 13 incorporates the image data processing device according to this embodiment.

The image data to which predetermined image processing has been performed by the image processing device 13 is converted to tone data of four colors of yellow (Y), magenta (M), cyan (C) and black (K) (eight bits each) by the same image processing device 13. The tone data are sent to a raster output scanner (ROS) 24 common to image forming units 23Y, 23M, 23C and 23K for the individual colors of yellow (Y), magenta (M), cyan (C) and black (K), as will be described hereinafter. This ROS 24 as an image exposure device performs image exposure with a laser beam LB in accordance with tone data of a predetermined color. The image is not limited to color image and it is possible to form black-and-white images only.

Meanwhile, an image forming part A is provided within the color multifunction machine 3, as shown in FIG. 3. In this image forming part A, the four image forming units 23Y, 23M, 23C and 23K for yellow (Y), magenta (M), cyan (C) and black (K) are arranged in parallel at a predetermined interval in the horizontal direction.

All of these four image forming units 23Y, 23M, 23C and 23K have the same construction. Generally, each of them has a photosensitive drum 25 as an image carrier rotationally driven at a predetermined speed, a charging roll 26 for primary charge that uniformly charges the surface of the photosensitive drum 25, the ROS 24 as an image exposure device that exposes an image corresponding to a predetermined color onto the surface of the photosensitive drum 25 and thus forms an electrostatic latent image thereon, a developing unit 27 that develops the electrostatic latent image formed on the photosensitive drum 25 with toner of a predetermined color, and a cleaning device 28 that cleans the surface of the photosensitive drum 25. The photosensitive drum 25 and the image forming members arranged in its periphery are integrally constructed as a unit, and this unit can be individually replaced from the printer and multifunction machine body 10.

The ROS 24 is constructed to be common to the four image forming units 23Y, 23M, 23C and 23K, as shown in FIG. 3. It modulates four semiconductor lasers, not shown, in accordance with the tone data of each color and emits laser beams LB-Y, LB-M, LB-C and LB-K from these semiconductor lasers in accordance with the tone data. The ROS 24 may be constructed individually for each of the plural image forming units. The laser beams LB-Y, LB-M, LB-C and LB-K emitted from the semiconductor lasers are cast onto a polygon mirror 29 via an f-θ lens, not shown, and deflected for scanning by this polygon mirror 29. The laser beams LB-Y, LB-M, LB-C and LB-K deflected for scanning by the polygon mirror 29 are caused to scan an exposure point on the photosensitive drum 25 for exposure from obliquely below, via an image forming lens and plural mirrors, not shown.

Since the ROS 24 is for scanning and exposing an image on the photosensitive drum 25 from below, as shown in FIG. 3, there is a risk of the ROS 24 being contaminated or damaged by falling toner or the like from the developing units 27 of the four image forming units 23Y, 23M, 23C and 23K situated above. Therefore, the ROS 24 has its periphery sealed by a rectangular solid frame 30. At the same time, transparent glass windows 31Y, 31M, 31C and 31K as shield members are provided at the top of the frame 30 in order to expose the four laser beams LB-Y, LB-M, LB-C and LB-K on the photosensitive drums 25 of the image forming units 23Y, 23M, 23C and 23K.

From the image data processing device 13, the image data of each color is sequentially outputted to the ROS 24, which is provided in common with the image forming units 23Y, 23M, 23C and 23K for yellow (Y), magenta (M), cyan (C) and black (K). The laser beams LB-Y, LB-M, LB-C and LB-K emitted from the ROS 24 in accordance with the image data are caused to scan and expose on the surfaces of the corresponding photosensitive drums 25, thus forming electrostatic latent images thereon. The electrostatic latent images formed on the photosensitive drums 25 are developed as toner images of yellow (Y), magenta (M), cyan (C) and black (K) by the developing units 27Y, 27M, 27C and 27K.

The toner images of yellow (Y), magenta (M), cyan (C) and black (K) sequentially formed on the photosensitive drums 25 of the image forming units 23Y, 23M, 23C and 23K are transferred in a multiple way onto an intermediate transfer belt 35 of a transfer unit 32 arranged above the image forming units 23Y, 23M, 23C and 23K, by four primary transfer rolls 36Y, 36M, 36C and 36K. These primary transfer rolls 36Y, 36M, 36C and 36K are arranged at parts on the rear side of the intermediate transfer belt 35 corresponding to the photosensitive drums 25 of the image forming units 23Y, 23M, 23C and 23K. The volume resistance value of the primary transfer rolls 36Y, 36M, 36C and 36K in this embodiment is adjusted to 105 to 108 Ωcm. A transfer bias power source (not shown) is connected to the primary transfer rolls 36Y, 36M, 36C and 36K, and a transfer bias having reverse polarity of predetermined toner polarity (in this embodiment, transfer bias having positive polarity) is applied thereto at predetermined timing.

The intermediate transfer belt 35 is laid around a drive roll 37, a tension roll 34 and a backup roll 38 at a predetermined tension, as shown in FIG. 3, and is driven to circulate in the direction of arrow at a predetermined speed by the drive roll 37 rotationally driven by a dedicated driving motor having excellent constant-speed property, not shown. The intermediate transfer belt 35 is made of, for example, a belt material (rubber or resin) that does not cause charge-up.

The toner images of yellow (Y), magenta (M), cyan (C) and black (K) transferred in a multiple way on the intermediate transfer belt 35 are secondary-transferred onto a paper 40 as a sheet material by a secondary transfer roll 39 pressed in contact with the backup roll 38, as shown in FIG. 3. The paper 40 on which the toner images of these colors have been transferred is transported to a fixing unit 50 situated above. The secondary transfer roll 39 is pressed in contact with the lateral side of the backup roll 38 and is adapted for performing secondary transfer of the toner image of each color onto the paper 40 transported upward from below.

As the paper 40, papers of a predetermined size from one of plural stages of paper feed trays 41, 42, 43 and 44 provided in the lower part of the color multifunction machine body 10 are separated one by one by a feed roll 45 and a retard roll 46 and each separated paper is fed via a paper transport path 48 having a transport roll 47. Then, the paper 40 fed from one of the paper feed trays 41, 42, 43 and 44 is temporarily stopped by a registration roll 49 and then fed to the secondary transfer position on the intermediate transfer belt 35 by the registration roll 49 synchronously with the image on the intermediate transfer belt 35.

The paper 40 to which the toner image of each color has been transferred is fixed with heat and pressure by the fixing unit 50, as shown in FIG. 3. After that, the paper 40 is transported by a transport roll 51 to go through a first paper transport path 53 for discharging the paper with its image forming side down to a face-down tray 52 as a first discharge tray, and then discharged onto the face-down tray 52 provided in the upper part of the device body 10 by a discharge roll 54 provided at the exit of the first paper transport path 53.

In the case of discharging the paper 40 having an image formed thereon as described above with its image forming side up, the paper 40 is transported through a second paper transport path 56 for discharging the paper with its image forming side up to a face-up tray 55 as a second discharge tray, and then discharged onto the face-up tray 55 provided at a lateral part of the device body 10 by a discharge roll 57 provided at the exit of the second paper transport path 56, as shown in FIG. 3.

In the color multifunction machine 3, when taking double-side copy of full color or the like, the transport direction of the recording paper 40 with an image fixed on its one side is switched by a switching gate, not shown, instead of directly discharging the paper 40 onto the face-down tray 52 by the discharge roll 54, and the discharge roll 54 is temporarily stopped and then reversed to transport the paper 40 into a double-side paper transport path 58 by the discharge roll 54, as shown in FIG. 3. Then, through this double-side paper transport path 58, the recording paper 40 with its face and rear sides reversed is transported again to the registration roll 49 by a transport roller 59 provided along the transport path 58. This time, an image is transferred and fixed onto the rear side of the recording paper 40. After that, the recording paper 40 is discharged onto either the face-down tray 52 or the face-up tray 55 via the first paper transport path 53 or the second paper transport path 56.

In FIG. 3, 60Y, 60M, 60C and 60K represent toner cartridges that supply toner of a predetermined color each to the developing units 27 for yellow (Y), magenta (M), cyan (C) and black (K).

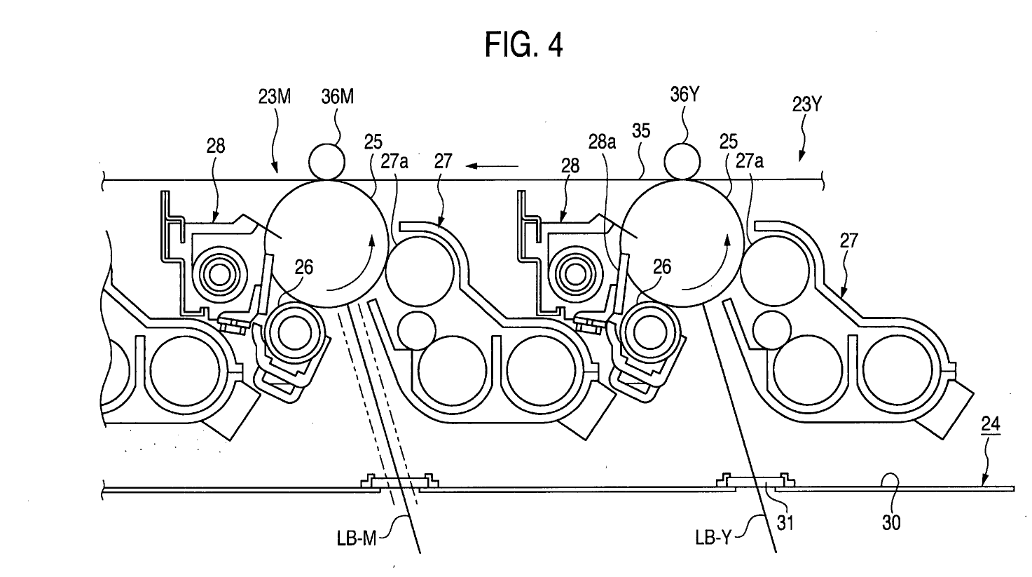

FIG. 4 shows each image forming unit of the color multifunction machine 3.

As shown in FIG. 4, all the four image forming units 23Y, 23M, 23C and 23K for the colors of yellow (Y), magenta (M), cyan (C) and black (K) are similarly constructed. In these four image forming units 23Y, 23M, 23C and 23K, toner images of the colors of yellow, magenta, cyan and black are sequentially formed at predetermined timing, as described above. The image forming units 23Y, 23M, 23C and 23K for these colors have the photosensitive drums 25, as described above, and the surfaces of these photosensitive drums 25 are uniformly charged by the charging rolls 26 for primary charge. After that, the image forming laser beams LB emitted from the ROS 24 in accordance with the image data are caused to scan on the surfaces of the photosensitive drums 25 for exposure, thus forming electrostatic latent images corresponding to each color. The laser beams LB scanned on the photosensitive drums 25 for exposure are set to be cast from a position slightly to the right of directly below the photosensitive drum 25, that is, obliquely below. The electrostatic latent images formed on the photosensitive drums 25 are developed into visible toner images by developing rolls 27a of the developing units 27 of the image forming units 23Y, 23M, 23C and 23K using the toners of yellow, magenta, cyan and black. These visible toner images are sequentially transferred in a multiple way onto the intermediate transfer belt 35 by the charging of the primary transfer rolls 36.

From the surfaces of the photosensitive drums 25 after the toner image transfer process is finished, the remaining toner, paper particles and the like are eliminated by the cleaning devices 28, thus getting ready for the next image forming process. The cleaning device 28 has a cleaning blade 28a. This cleaning blade 28a eliminates the remaining toner, paper particles and the like from the surface of the photosensitive drum 25. From the surface of the intermediate transfer belt 35 after the toner image transfer process is finished, the remaining toner, paper particles and the like are eliminated by a cleaning device 61, as shown in FIG. 3, thus getting ready for the next image forming process. The cleaning device 61 has a cleaning brush 62 and a cleaning blade 63. These cleaning brush 62 and cleaning blade 63 eliminate the remaining toner, paper particles and the like from the surface of the intermediate transfer belt 35.

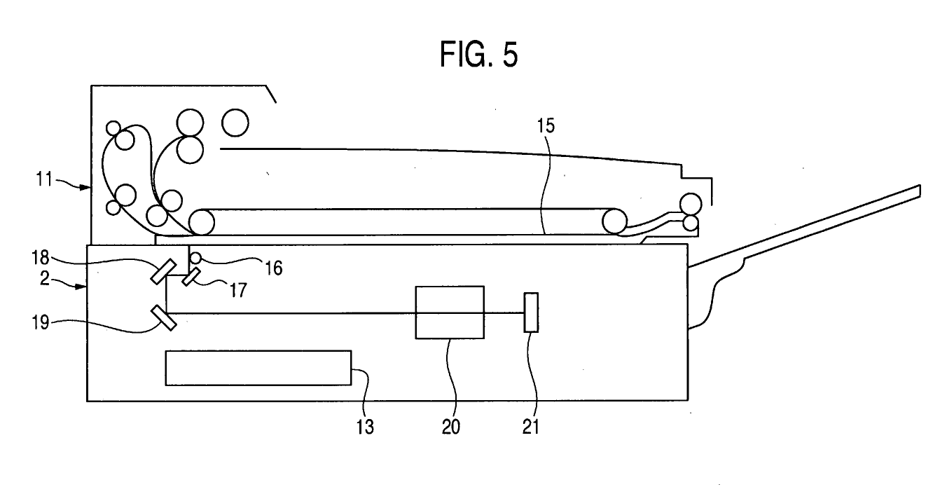

FIG. 5 shows the scanner 2 as an image reading device that is singly installed.

This scanner 2 has the same construction as the scanner 9 of the color multifunction machine 3. However, the image processing device 13 is installed within the scanner 2.

The image data processing device according to an aspect of the invention is an image data processing device for performing predetermined processing to inputted image data including plural pages. The device includes: an image identifying unit that identifies a common image that is common to each page and a non-common image that differs from page to page on the basis of the inputted image data including plural pages; and a file generating unit that generates separate files of the common image that is common to each page and the non-common image differing from page to page, identified by the image identifying unit.

In this embodiment, the image identifying unit includes: a common image recognizing unit that recognizes a common image that is common to each page on the basis of the inputted image data including plural pages; a common image extracting unit that extracts the common image recognized by the common image recognizing unit from the inputted image data of each page; and a common image removing unit that removes the common image extracted by the common image extracting unit from the inputted image data of each page and thus acquires a non-common image that differs from page to page.

Moreover, in this embodiment, the common image recognizing unit detects a recognition marker for alignment appended to the inputted image data of each page and adjusts the position of the inputted image data of each page on the basis of the result of the detection of the recognition marker.

Also, in this embodiment, the common image recognizing unit performs bit expansion processing to the inputted image data of each page and thus recognizes a common image.

Moreover, in this embodiment, the common image recognizing unit recognizes a common image that is common to image data of an n-th page and an (n+1)th page, of the inputted image data of each page, then recognizes a common image that is common to the result of the recognition and image data of an (n+2)th page, and similarly recognizes a common image that is common to the result of the recognition up to a previous page and image data of a current page.

In this embodiment, the image data processing device also includes: a separating unit that separates the common image and the non-common image identified by the image identifying unit into a text part and an image part; and a slicing unit that slices out at least one rectangular part of the text part separated by the separating unit. The rectangular part sliced out by the slicing unit is managed on the basis of the number of pages, position information of the recognition marker and length information in x- and y-directions representing the rectangular part.

Moreover, in this embodiment, character recognition of the text image of the rectangular part sliced out by the slicing unit is performed by using character recognition software and the recognized character image data is converted to a character code.

In this embodiment, the image data processing device also includes a selecting unit that selects whether to generate the image of the rectangular part sliced out by the slicing unit, as bit map data or as a character code.

For example, an image data processing device 100 according to this embodiment is arranged as it is incorporated as a part of the image processing device 13, within the color multifunction machine 3 as an image output device, as shown in FIG. 3. This image data processing device 100 may also be constructed by installing software for image data processing in the personal computer 5 or the like. Moreover, the image data processing device 100 may also be arranged as it is incorporated as a part of the image processing device 13, within the scanner 2 as an image reading device, as shown in FIG. 5.

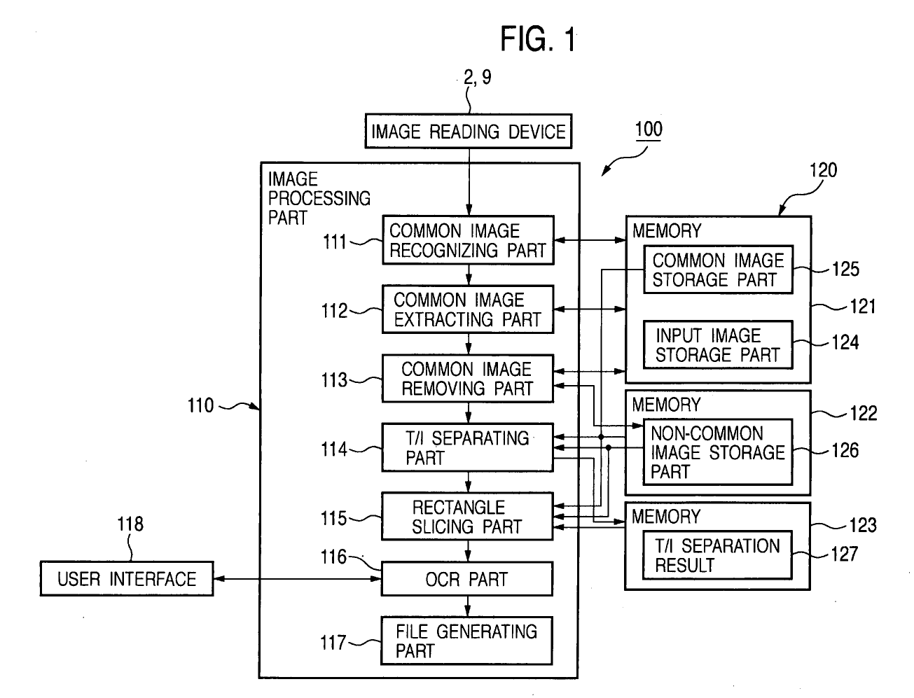

This image data processing device 100 roughly includes an image processing part 110 as an image processing unit to which image data is inputted from the scanner 2, 9 as an image reading device and which performs predetermined image processing to the inputted image data, and a memory part 120 that stores image data inputted thereto and the image data or the like to which predetermined image processing has been performed by the image processing part 110, as shown in FIG. 1. The image processing part 110 has a common image recognizing part 111, a common image extracting part 112, a common image removing part 113, a T/I separating part 114, a rectangle slicing part 115, an OCR part 116, and a file generating part 117. The memory part 120 has a first memory 121, a second memory 122, and a third memory 123. The common image recognizing part 111, the common image extracting part 112 and the common image removing part 113 together form an image identifying unit. In the embodiment, while the term “part” as in “file generating part 117” is used, the term “part” should be considered similar to “unit”.

Image data of plural pages inputted from the image reading device 2, 9 are temporarily stored in an input image storage part 124 of the first memory 121 via the common image recognizing part 111. The common image recognizing part 111 is for recognizing a common image that is common to each page based on the image data of plural pages inputted from the image reading device 2, 9 and temporarily stored in the input image storage part 124 of the first memory. This common image recognizing part 111 is constructed to compare image data of individual pages with each other, for example, compare the image data of the first page with the image data of the second page, thus recognizing a common image that is common to each of the pages.

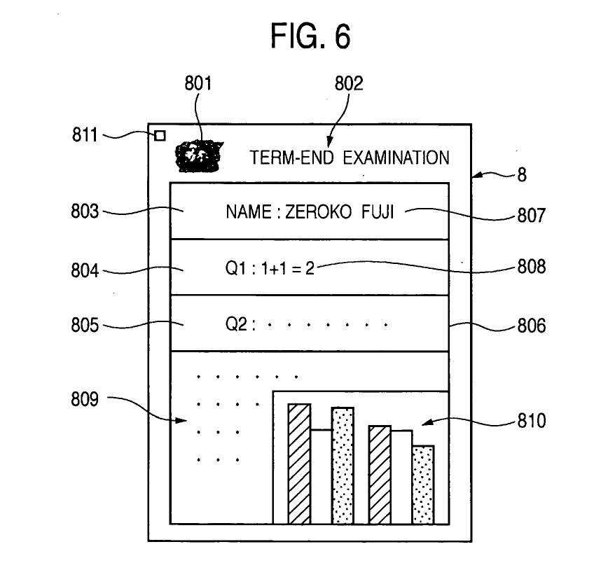

The document 8 covering plural pages read by the image reading device 2, 9 is not particularly limited. It may be, for example, an examination sheet used at a school or cram school, as shown in FIG. 6, or a document of fixed form used at a corporate office or public office, and the like. However, the document is not limited to these and may be documents of other types. In this document 8 formed as an examination sheet, a pattern 801 such as the mark of a company that produces the examination sheet, a character image 802 showing the title of the document such as term-end examination or subject, characters of “NAME” 803 described in a section where an examinee is to write his/her name, question texts 804, 805 including characters showing question numbers such as “Q1”, “Q2” and so on, a straight frame image 806 showing a rectangular frame around the “NAME” section and the question text sections, and the like are described in advance by printing, a print or the like, as shown in FIG. 6. In the document 8 of examination sheet, the examinee describes his/her name 807, a numeral 808 as an answer, or a sentence 809 or a pattern 810 such as bar chart as an answer by handwriting.

Also, in the document 8 of examination sheet, a recognition marker 811 for alignment formed in a predetermined shape such as rectangle or cross is described in advance by printing, a print or the like at a predetermined position such as upper left corner, as shown in FIG. 6.

The common image recognizing unit 111 detects the recognition marker 811 for alignment appended to the inputted image data of each page. The common image recognizing unit 111 adjusts the position of the inputted image of each page on the basis of the result of the detection of the recognition marker 811. Therefore, even if the pattern 801, the character image 802 and the like deviated from an edge of the paper 8 is described by printing in each page of the document 8, the position of the inputted image data of each page is adjusted with reference to the position of the recognition marker 811, thereby enabling recognition of an image common to the individual pages without any error.

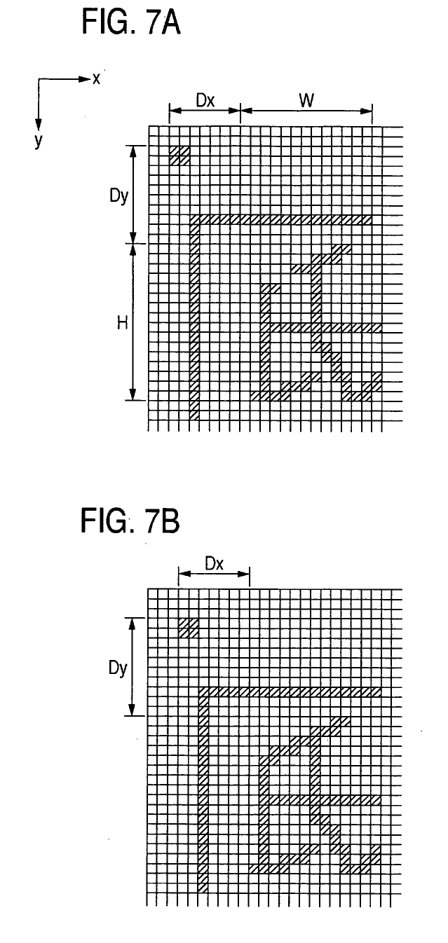

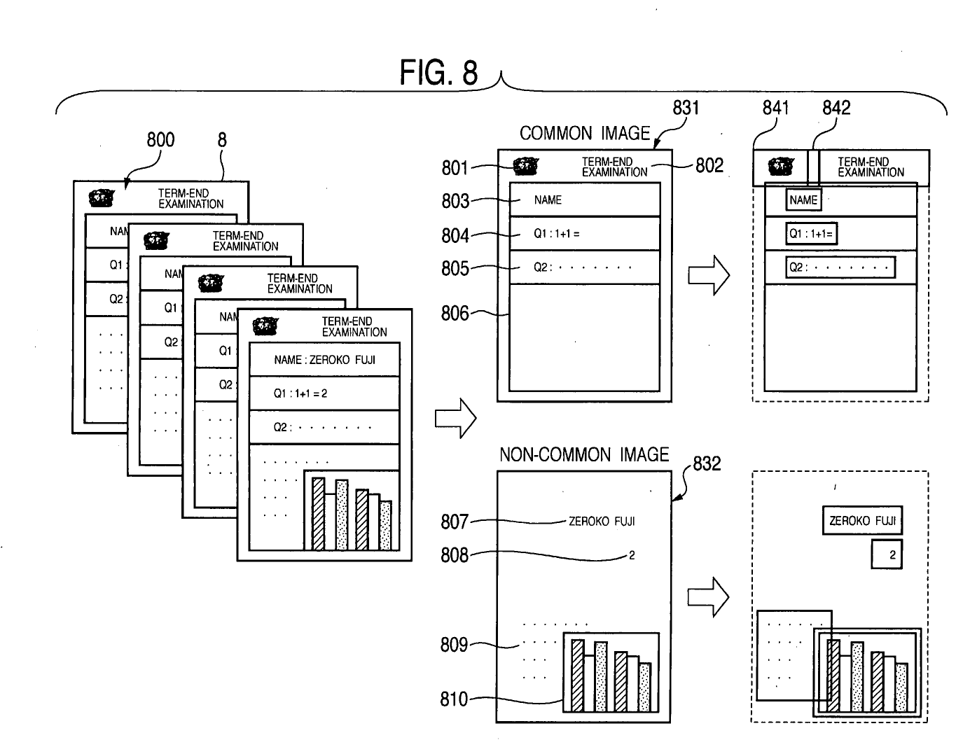

More specifically, as shown in FIGS. 7A and 7B, even if the image data acquired by reading the image of each page has an overall misalignment from the edge of the paper 8, the common image recognizing unit 111 adjusts the position of the image data of each page, for example, by finding the width W in the x-direction and the height H in the y-direction of a rectangle circumscribing the character image 803 with reference to the distances Dx and Dy in the x-direction and y-direction from the recognition marker 811 to the character image 803 or the like. Then, this common image recognizing part 111 recognizes a common image that is common to the image data of the first and second pages of the inputted image data of each page, recognizes a common image that is common to the result of the previous recognition and the image data of the third page, and similarly recognizes a common image that is common to the result of the recognition up to the previous page and the image data of the current page, as shown in FIG. 8.

In this case, the common image recognizing unit 111 performs bit expansion processing to the inputted image data of each page and thus recognizes a common image. In short, in case where the image of each page is the frame-like image 806 as shown in FIG. 6, if the image data of the first page and the image data of the second page are deviated from each other only approximately one bit, the frame-like image 806 might not be recognized as a common image.

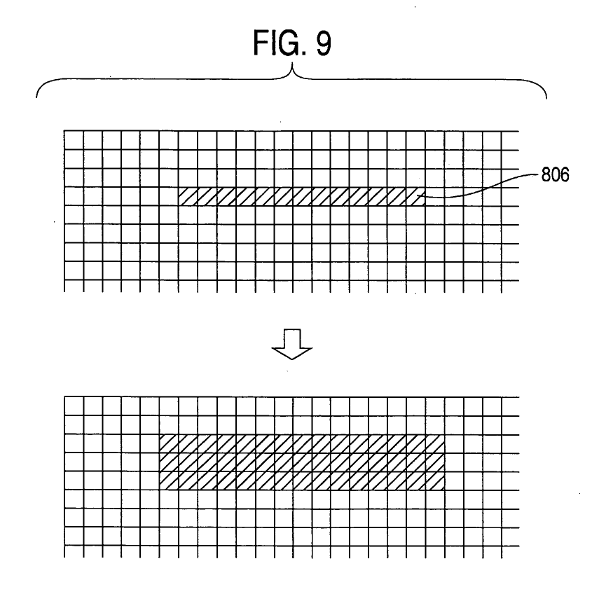

In this embodiment, for an image having a small number of bits like the frame-like image 806, a common image is recognized after bit expansion processing is performed to increase the number of bits of the frame-like image 806 by several bits from one bit in the vertical and horizontal directions, particularly as shown in FIG. 9.

The common image extracting part 112 extracts the common image that is common to the individual pages recognized by the common image recognizing unit 111, from the inputted image data of each page. Then, the common image extracted by the common image extracting part 112 is stored into a common image storage part 125 of the first memory 121.

Moreover, the common image removing part 113 performs processing to remove the common image extracted by the common image extracting part 112 from the inputted image data of each page, and finds a non-common image that differs from page to page of the image data. The non-common image found by the common image removing part 113 is stored into a non-common image storage part 126 of the second memory 122.

The T/I separating part 114 is for separating the inputted image data of each page into a text part made up of a character image or the like, and an image part made up of an image of pattern or the like. The T/I separating part 114 is formed by a known text/image separating unit. The information of the text part and the information of the image part of the image data of each page separated by the T/I separating part 114 are separately stored as T/I separation result 127 into the third memory 123 in a manner that enables the information to be read out on proper occasions.

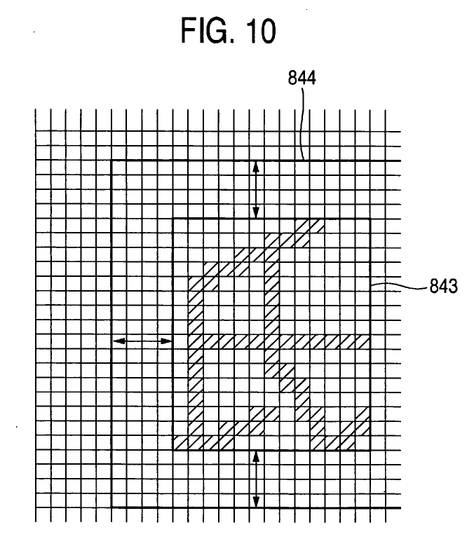

The rectangle slicing part 115 is constructed to slice out at least one or more rectangular parts from the image of the text part and the image of the image part separated by the T/I separating part 114, of the common image and the non-common image of each page. The slicing of the rectangular image by the rectangle slicing part 115 is performed by designating the image of the image part and the image of the text part of the common image and the non-common image of the input image data, diagonally at upper left corner 841 and lower right corner 842, for example, by using a touch panel or mouse provided on the user interface of the color multifunction machine, as shown in FIG. 8. The slicing of the rectangular image by the rectangle slicing part 115 may also be performed by automatically slicing out a rectangular area 844 that is outside by a predetermined number of bits from a rectangular part 843 circumscribing the image of the text part such as the characters 803 of “NAME” or the image of the image part, as shown in FIG. 10. Even for the characters of “NAME” or the like that are next to each other, if the spacing between the characters is smaller than a predetermined number of bits, they are sliced out as the same rectangular area 844.

The OCR part 116 performs character recognition of the image data separated as the text part by the T/I separating part 114, of the rectangular image sliced out by the slicing part 115, and converts the image data to a character code.

Moreover, the file generating part 117 separately converts the image data of the common image and the image data of the non-common image of the input image data to electronic data and thus generates file data such as PDF file or PostScript.

In the image data processing device according to this embodiment, it is possible to significantly reduce the quantity of data by identifying an image that is common to individual pages of image data and a non-common image and processing them separately in the following manner. Specifically, in the image processing system 1 to which the image data processing device 100 according to this embodiment is applied, images of the document 8 or the like including plural pages are read by the scanner 2 or the scanner 9 as an image reading device, as shown in FIG. 2. The image data of the document 8 or the like including plural pages read by the scanner 2, 9 is inputted to the color multifunction machine 3 as an image output device in which the image data processing device 100 is installed, as shown in FIG. 1. The document 8 including plural pages read by the scanner 2, 9 may be, for example, an examination sheet used at a school or cram school, a document of fixed form used at a corporate office or public office, and the like, as shown in FIG. 6. To the image data processing device 100, the image data of the document 8 including plural pages read by the scanner 2, 9 as an image reading device are inputted, and a common image that is common to the individual pages of the inputted image data is recognized by the common image recognizing part 111 on the basis of the inputted image data of plural pages, as shown in FIG. 1. As the image data of the document 8 recognized by the common image recognizing part 111, for example, binarized image data is used, but multi-valued image data may be used without binarization. For a color image, a part having image data is regarded as an image, irrespective of its color.

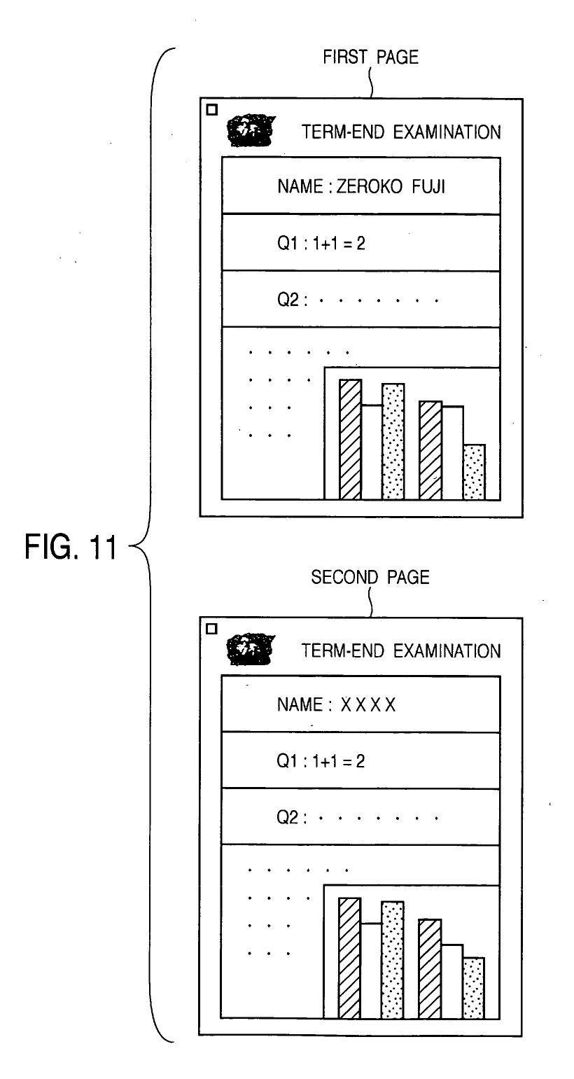

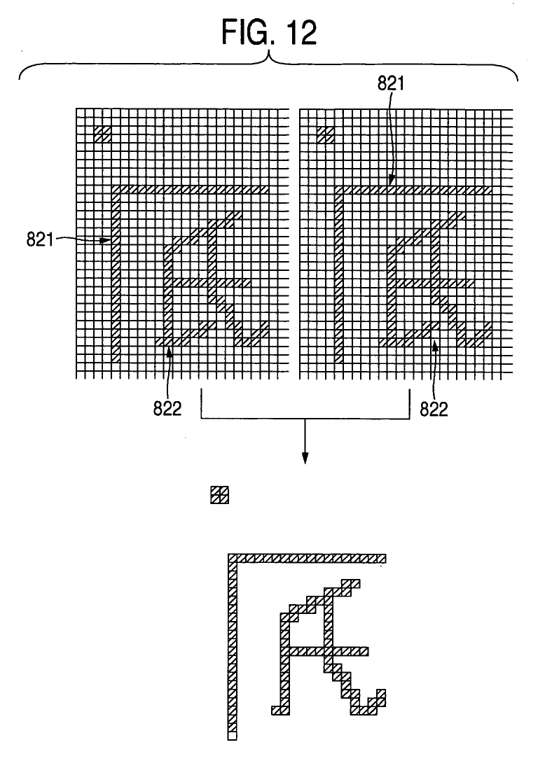

For example, when image data 800 including plural pages of examination sheets 8 for term-end examination on which name and answers have been written are inputted as shown in FIG. 8, the common image recognizing part 111 compares the image data 800 of the individual pages by each bit, such as the image data of the first page and the image data of the second page as shown in FIG. 11, and recognizes common images 821, 822 and the like as shown in FIG. 12. The common images recognized by the common image recognizing part ill are temporarily stored in the common image storage part 125 of the first memory 121. Next, the common images that are common to the image data of the first page and the image data of the second page, stored in the common image storage part 125, are compared with the image data of the third page by the common image recognizing part 111. A common image or common images are thus recognized and temporarily stored in the common image storage part 125 of the first memory 121.

In this manner, the common image recognizing part 111 recognizes a common image that is common to the image data of the first page and the second page, of the inputted image data of each page. The common image that is common to the image data of the first page and the second page is thus identified, as shown in FIG. 8. Next, the common image recognizing part 111 recognizes a common image that is common to the result of the identification of the common image of the image data of the first and second pages and the image data of the third page. In this manner, the common image recognizing part 111 identifies a common image that is common to the image data of the n-th page and the (n+1)th page of the inputted image data of each page, then identifies a common image that is common to the result of the identification and the image data of the (n+2)th page, and similarly identifies a common image that is common to the result of the identification up to the previous page and the image data of the current page. In this case, since the identification of common images is sequentially performed, there is an advantage that the common image recognizing part 111 can be constructed simply. As a result, the common images that are common to the images of the individual pages are identified by the common image recognizing part 111 and these common images are stored into the common image storage part 125 of the first memory 121. The common image recognizing part 111 may simultaneously compare the image data of all the pages and thus identify the common images.

Next, the common image extracting part 112 extracts a common image 831 on the basis of the result of the recognition of the common image, which is the result of the comparison of the image data of the individual pages by the common image recognizing part 111 as shown in FIG. 8. The common image 831 extracted by the common image extracting part 112 is stored into the common image storage part 125 of the first memory 121.

Next, the common image removing part 113 removes the common image 831 extracted by the common image extracting part 112 and stored in the common image storage part 125, from the image data of each page stored in the input image storage part 124 of the first memory 121, thus providing a non-common image 832 that differs from page to page, as shown in FIG. 8. These non-common images 832 are stored into the non-common image storage part 126 of the second memory 122.

After that, the common image 831 and the non-common images 832 are divided into a text part and an image part by the T/I separating part 114 as shown in FIG. 1. The common image has, a text part including the character image 802 showing the title of document such as term-end examination, the characters 803 of “NAME” described in the section where an examinee is to write his/her name, and the question texts 804, 805 including characters representing question numbers such as “Q1”, “Q2” and so on, and an image part including the pattern 801 such as mark representing the company that produces the examination sheep or the subject and the straight frame image 806 showing a rectangular frame around the “NAME” section and the question text section are separated, as shown in FIG. 8. The result of the separation of the text part and the image part is stored into the third memory 123 as a T/I separation result.

A text part and an image part of the non-common image 832 are separated and stored into the third memory 123 as a T/I separation result. The text part has the name 807 of the examinee, the numeral 808 as an answer or the sentence 809 as an answer, and the image part has the pattern 810 such as bar chart as shown in FIG. 8.

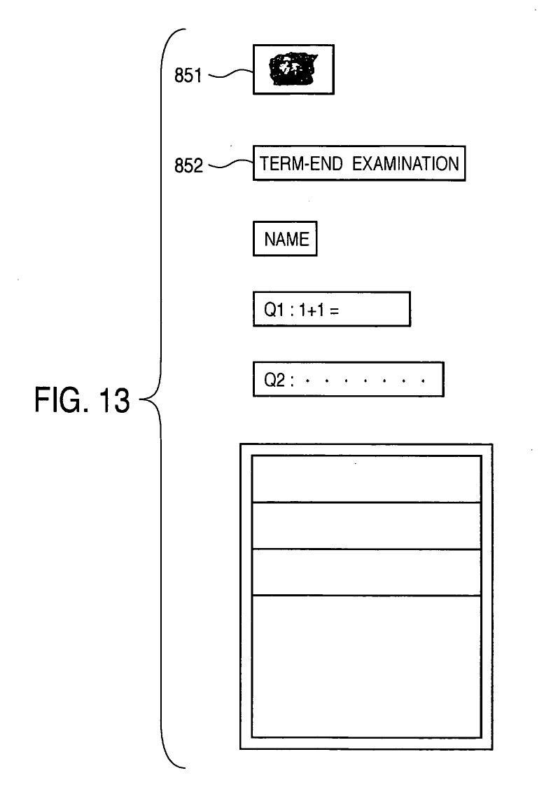

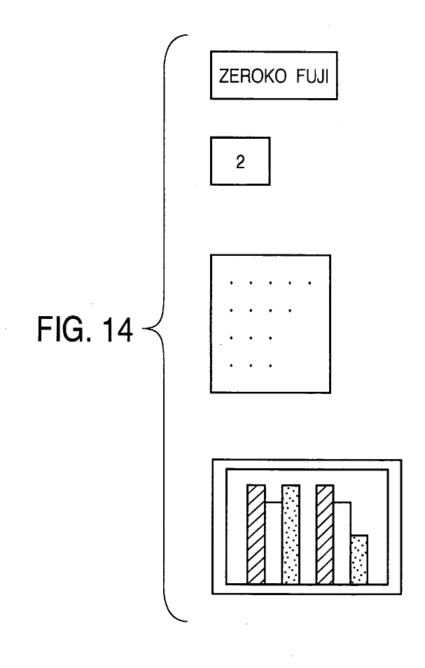

Next, from the common image 831 and the non-common image 832 separated into the text part and the image part by the T/I separating part 114, each image data of the text part and the image part is sliced out into rectangular slicing frames 851, 852 and so on by the rectangle slicing part 115, as shown in FIGS. 8, 13 and 14.

A user interface (selecting unit) 118 (see FIG. 1) of the color multifunction machine 3 or the like that instructs the processing operation of the image data processing device 100 can select whether to generate the image sliced out in the rectangular shape, in the form of bit map, or as a character code by using the OCR part 116.

Then, each of the image data of the text part sliced out in the rectangular shape by the rectangle slicing part 115 is, for example, character-recognized and converted to a character code by the OCR part 116.

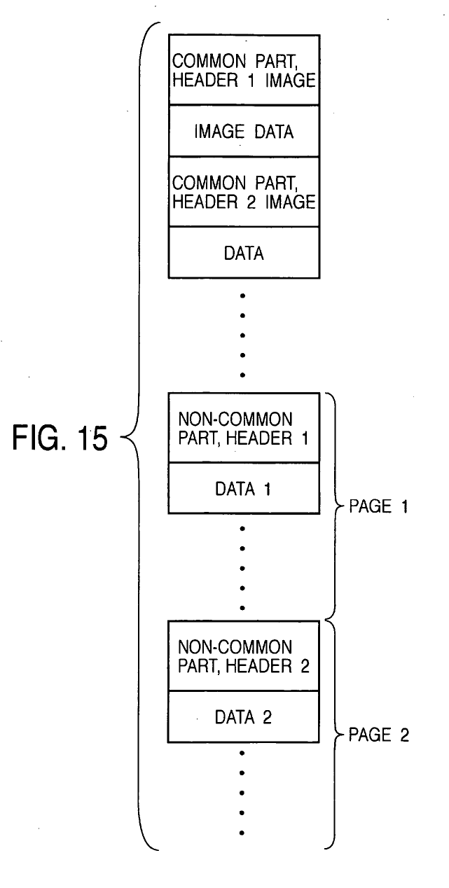

Finally, the inputted image data are filed by the file generating part 117 based on data including the character code recognized from the text image, the size of the character and the position of the character, and data including the content and position of the image of the image part. Thus, files are generated including the first header of the common part and data of image 1 that is the first common part, then, the second header of the common part and data of text 1 that is the second common part, . . . , the first header of the non-common part of the first page and data that is the first non-common part, then, the second header of the non-common part and data that is the second non-common part, . . . , the first header of the non-common part of the second page and data that is the first non-common part, then, the second header of the non-common part and data that is the second non-common part, and so on, as shown in FIG. 15. The type of these files may be arbitrary, like PDF files or PostScript files.

Thus, since only one image data suffices for a common image even in a document or the like including tens of pages, storage, print or transfer of the image data of the document or the like including tens of pages can be carried out with a small quantity of data and in a short time.

In this manner, in the image data processing device 100 according to the embodiment, the common image 831 that is common to image data of each page of input image data including plural pages and the non-common images 832 are discriminated and separately processed. Therefore, only one common image 831 suffices and the common image need not be provided as data in each page, thus enabling significant reduction in the quantity of data.

As described above, some embodiments of the invention are outlined below.

According to an aspect of the invention, an image data processing device for performing predetermined processing to inputted image data including plural pages includes: an image identifying unit that identifies a common image that is common to each page and a non-common image that differs from page to page on the basis of the inputted image data including plural pages; and a file generating unit that generates separate files of the common image that is common to each page and the non-common image differing from page to page, identified by the image identifying unit.

In the image data processing device, the image identifying unit includes: a common image recognizing unit that recognizes a common image that is common to each page on the basis of the inputted image data including plural pages; a common image extracting unit that extracts the common image recognized by the common image recognizing unit from the inputted image data of each page; and a common image removing unit that removes the common image extracted by the common image extracting unit from the inputted image data of each page and thus acquires a non-common image that differs from page to page.

Moreover, in the image data processing device, the common image recognizing unit detects a recognition marker for alignment appended to the inputted image data of each page and adjusts the position of the inputted image data of each page on the basis of the result of the detection of the recognition marker.

Also, in the image data processing device, the common image recognizing unit performs bit expansion processing to the inputted image data of each page and thus recognizes a common image.

Moreover, in the image data processing device, the common image recognizing unit recognizes a common image that is common to image data of an n-th page and an (n+1)th page, of the inputted image data of each page, then recognizes a common image that is common to the result of the recognition and image data of an (n+2)th page, and similarly recognizes a common image that is common to the result of the recognition up to a previous page and image data of a current page.

The image data processing device also includes: a separating unit that separates the common image and the non-common image identified by the image identifying unit into a text part and an image part; and a slicing unit that slices out at least one rectangular part of the text part separated by the separating unit; wherein the rectangular part sliced out by the slicing unit is managed on the basis of the number of pages, position information of the recognition marker and length information in x- and y-directions representing the rectangular part.

Moreover, in the image data processing device, character recognition of the text image of the rectangular part sliced out by the slicing unit is performed by using character recognition software and the recognized character image data is converted to a character code.

The image data processing device also includes a selecting unit that selects whether to generate the image of the rectangular part sliced out by the slicing unit, as bit map data or as a character code.

According to an aspect of the invention, an image data processing device can be provided that enables significant reduction in quantity of data by identifying a common image and a non-common image of image data of each page, of input image data including plural pages, and processing the non-common image and also processing the common image as a common image.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

The entire disclosure of Japanese Patent Application No. 2005-011540 filed on Jan. 19, 2005 including specification, claims, drawings and abstract is incorporated herein by reference in its entirety.

What is claimed is:

1. An image data processing device comprising:
an image identifying unit that identifies a common image that is common to each page and a non-common image that differs from page to page on the basis of inputted image data including a plurality of pages; and
a file generating unit that generates separate files of the common image and the non-common image.

2. The image data processing device as claimed in claim 1, wherein the image identifying unit includes:
a common image recognizing unit that recognizes a common image that is common to each page on the basis of the inputted image data including the plurality of pages;
a common image extracting unit that extracts the common image recognized by the common image recognizing unit from the inputted image data of each page; and
a common image removing unit that removes the common image extracted by the common image extracting unit from the inputted image data of each page and thus acquires a non-common image that differs from page to page.

3. The image data processing device as claimed in claim 2, wherein the common image recognizing unit detects a recognition marker for alignment appended to the inputted image data of each page and adjusts the position of the inputted image data of each page on the basis of the result of the detection of the recognition marker.

4. The image data processing device as claimed in claim 2, wherein the common image recognizing unit performs bit expansion processing to the inputted image data of each page and thus recognizes a common image.

5. The image data processing device as claimed in claim 2, wherein the common image recognizing unit recognizes a common image that is common to image data of an n-th page and an (n+1)th page, of the inputted image data of each page, then recognizes a common image that is common to the result of the recognition and image data of an (n+2)th page, and similarly recognizes a common image that is common to the result of the recognition up to a previous page and image data of a current page.

6. The image data processing device as claimed in claim 1, further comprising:
a separating unit that separates the common image and the non-common image identified by the image identifying unit into a text part and an image part; and
a slicing unit that slices out at least one rectangular part of the text part separated by the separating unit, wherein the rectangular part sliced out by the slicing unit is managed on the basis of the number of pages, position information of the recognition marker and length information in x- and y-directions representing the rectangular part.

7. The image data processing device as claimed in claim 6, wherein character recognition of the text image of the rectangular part sliced out by the slicing unit is performed by using character recognition software and the recognized character image data is converted to a character code.

8. The image data processing device as claimed in claim 7, further comprising:
a selecting unit that selects whether to generate the image of the rectangular part sliced out by the slicing unit, as bit map data or as a character code.

9. An image data processing method comprising:
identifying a common image and a non-common image from inputted image data, the common image being common to each page, the non-common image being different from page to page, the inputted image data having a plurality of pages; and
generating files of the common image and the non-common image separately.

10. The image data processing method according to claim 9, further comprising:
extracting the common image from the inputted image data of each page; and
removing the extracted common image from the inputted image data of each page and thus acquiring a non-common image that differs from page to page.

11. The image data processing method according to claim 9, further comprising:
detecting a recognition marker for alignment appended to the inputted image data of each page,
adjusting the position of the inputted image data of each page on the basis of the result of the detection of the recognition marker.

12. The image data processing method according to claim 9, further comprising:
performing a bit expansion processing to the inputted image data of each page; and
recognizing a common image based on the inputted image data performed by the bit expansion processing.

13. The image data processing method according to claim 9, further comprising:
separating the common image and the non-common image into a text part and an image part; and
slicing out at least one rectangular part of the separated text part,
wherein the sliced out rectangular part is managed on the basis of the number of pages, position information of the recognition marker and length information in x- and y-directions representing the rectangular part.

14. The image data processing method according to claim 13, further comprising:
performing character recognition of the text image of the sliced out rectangular part by using character recognition software; and
converting the recognized character image data to a character code.

15. The image data processing method according to claim 14, further comprising:
selecting whether to generate the image of the sliced out rectangular part as bit map data or as a character code.

16. A storage medium readable by a computer, the storage medium storing a program of instructions executable by the computer to perform a function for performing an image data processing, the function comprising:
identifying a common image and a non-common image from inputted image data, the common image being common to each page, the non-common image being different from page to page, the inputted image data having a plurality of pages; and
generating files of the common image and the non-common image separately.
